(19) United States
(12) Patent Application Publication
(10) Pub. No.: US 2012/0325779 A1
(43) Pub. Date: Dec. 27, 2012

(54) Alloy Depositing Machine And Method Of Depositing An Alloy Onto A Workpiece

(75) Inventor: Alexei Yelistratov, Dunlap, IL (US)

(73) Assignee: CATERPILLAR, INC., Peoria, IL (US)

(21) Appl. No.: 13/166,319

(22) Filed: Jun. 22, 2011

(51) Int. Cl. B23K 9/04

(52) U.S. Cl. 219/76.14; 219/76.1

(57) ABSTRACT

A hardfacing machine is used for depositing a hardfacing alloy onto a metallic workpiece. An welding unit includes a wire feed system to supply wire to a welding head. A powder alloy feeding system includes a powder feed nozzle fluidly connected to an alloy powder supply. The welding head and powder feed nozzle move in a travel direction relative to the workpiece. The powder feed nozzle is positioned and oriented to feed a powder stream of alloy powder into a molten pool generated on the workpiece by an electrical arc produced by the welding head at a low temperature location behind the welding head relative to the travel direction. This alloy surfacing strategy limits vaporization of alloy elements by avoiding the high temperature region associated with the electrical arc.

### TECHNICAL FIELD

The present disclosure relates generally to arc deposition of alloys onto metallic workpieces, and more particularly to an electrical arc machine that feeds a stream of alloy powder to a low temperature portion of a molten pool on the workpiece.

### BACKGROUND

Applying hardfacing alloy deposits to metallic workpieces as a strategy to combat wear problems has been known for almost 100 years. Depending upon the type of wear to be resisted, many different alloy compositions have been identified. Broadly speaking, hardfacing is a process by which a coating is applied to a workpiece for the purpose of reducing wear or loss of material through abrasion, impact, erosion, gulling, cavitation or some combination of these wear types. At one extreme, iron based alloys are relatively low cost and easy to apply with a low alloy wire that includes significant amounts of carbon, and maybe other alloy elements including manganese and/or silicon. Various carbide alloys might include measurable amounts of chromium, molybdenum, tungsten, vanadium and/or titanium, etc. In instances where abrasive wear is combined with potential corrosion, nickel based alloys might be desirable. When high temperatures are combined with potential corrosion and abrasion, cobalt based alloys might be desirable. In cases of extreme abrasive conditions, various combinations of tungsten carbide and vanadium carbide have found some success. In addition to those elements mentioned, other elements that sometimes appear in various hard alloy deposits include zirconium, boron, manganese, copper, aluminum, titanium and niobium, among others. U.S. Pat. No. 3,584,181 is of interest for teaching an example method of arc welding for hardfacing a metallic workpiece.

A wide variety of arc welding wires that contain various concentrations of these elements are available for producing hard-alloyed deposits with some desired chemistry. The cost of these specialty wires can be significant. In addition, waste can drive up costs because some or most of the desired alloy elements have vaporization temperatures that are lower than a temperature produced by the welding unit, which may be on the order of 5000-6000° C. For instance, manganese, cobalt aluminum and copper all boil at temperatures below 3000° C. Of the alloy elements mentioned, tungsten probably has the highest boiling temperature at around 5550° C. As a result, specialty wires often need to include surplus concentrations of certain alloy elements to account for an often sizable fraction of that element that is vaporized during the arc welding deposit procedure. This problem becomes more acute as element costs increase. In addition, because there are only a finite number of different specialty wires available, certain hard alloy deposit chemistries cannot be achieved without formulation of still more different specialty wires. Thus, the current process involves substantial waste producing increased cost, and provides a limited number of alloy recipe combinations.

The present disclosure is directed toward one or more of the problems set forth above.

### SUMMARY OF THE DISCLOSURE

In one aspect, an alloy depositing machine is used for depositing an alloy onto a workpiece. The machine includes a workpiece support, welding unit and a powder alloy feeding system. The welding unit includes a wire feed system to supply wire to a welding head. The powder alloy feeding system includes a powder feed nozzle fluidly connected to an alloy powder supply. The welding head and powder feed nozzle move in a travel direction relative to the workpiece. The powder feed nozzle is positioned and oriented to feed a powder stream of alloy powder into a molten pool generated on the workpiece by the welding head at a low temperature location behind the welding head relative to the travel direction.

In another aspect, a method of depositing an alloy onto a workpiece includes generating an electrical arc between a wire of a welding head and a workpiece. The Wire is melted into a molten pool with the electrical arc on the workpiece. The welding head is moved with respect to the workpiece in a travel direction. A mixture of powder alloys is added to the molten pool. Vaporization of a portion of the mixture is limited by penetrating a powder stream of the powder alloys into the molten pool at a low temperature location behind the electrical arc relative to the travel direction. The molten pool is then solidified.

### BRIEF DESCRIPTION OF THE DRAWINGS

FIG. 1 is a schematic view of an alloy depositing machine according to the present disclosure;

FIG. 2 is a side section view through a powder feed nozzle from the machine of FIG. 1; and

FIG. 3 is a bottom view of the powder feed nozzle of FIG. 2.

### DETAILED DESCRIPTION

The present disclosure recognizes that various elements that are preferred in making hardfacing alloys have a variety of different melting and boiling temperatures, all of which may be below the hottest area associated with an electrical arc from an welding unit, which may be on the order of 5000-6000° C. The table below lists the melting and boiling temperatures for a variety of different elements that commonly form different portions of a hardfacing alloy. Nevertheless, elements not listed on the below table but utilized in a significant concentration in a hardfacing alloy (or welding alloy) would still fall within the scope of the present disclosure.

| Element | T melting, ° C. (° F.) | T boiling, ° C. (° F.) |
|---|---|---|
| Manganese | 1250 (2280) | 2060 (3740) |
| Silicon | 1410 (2570) | 3265 (5909) |
| Molybdenum | 2617 (4742) | 4640 (8385) |
| Carbon | 3600 (6512) | 4827 (8720) |
| Chromium | 1857 (3374) | 2671 (4840) |
| Vanadium | 1900 (3450) | 3400 (6152) |
| Nickel | 1453 (2647) | 2900 (5252) |
| Tungsten | 3407 (6164) | 5550 (10022) |
| Zirconium | 1852 (3365) | 4400 (7952) |
| Boron | 2300 (4172) | 3927 (7100) |
| Copper | 1084 (1983) | 2562 (4643) |
| Aluminum | 660 (1220) | 2510 (4550) |
| Cobalt | 1495 (2723) | 2900 (5252) |
| Titanium | 1660 (3020) | 3260 (5900) |
| Niobium | 2470 (4478) | 4744 (8571) |

The present disclosure recognizes that temperatures within a molten pool generated by an electrical arc of an welding unit can vary significantly. In particular, the present disclosure recognizes that vaporization losses can be reduced if the alloy elements can be supplied to the molten pool at a location where the temperature is lower than the vaporization temperature for that element. For instance, an area of the molten pool with a surface temperature on the order of 1600-1800° might be suitable.

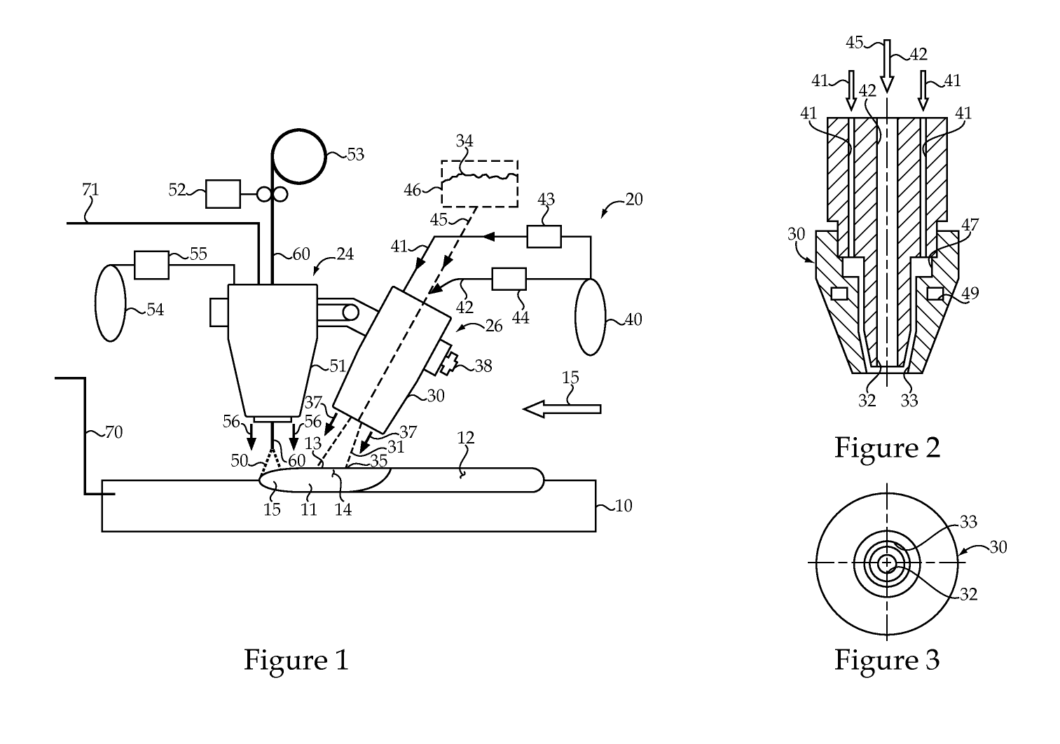

Referring to FIGS. 1-3, an alloy depositing machine 20 (hereinafter hardfacing machine 20) is used for depositing an alloy, such as a hardfacing alloy, onto a workpiece 10. Workpiece 10 may be supported on a workpiece support (not shown) that may be attached to a frame (not shown). Hardfacing machine 20 includes both an welding unit 24 and a powder alloy feeding system 26 may be attached to the frame. Although machine 20 has been illustrated with the various components (workpiece support 22, welding unit 24 and powder alloy feeding system 26) all apparently attached to a common frame, these components could be separated from one another without departing from the present disclosure. For instance, if the workpiece 10 is relatively large, welding unit 24 and feeding system 26 may be mounted on a robot that moves about on a factory floor relative to a stationary workpiece. On the other hand, if the workpiece 10 is smaller, the workpiece support might be a set of rails that allow the workpiece to move underneath a relatively fixed welding unit 24 and feeding system 26. In still another situation, the welding unit 24 and/or feeding system 26 may be suspended over workpiece 10, or vice versa, without departing from the present disclosure. The welding unit 24 includes a wire feed system 52 to supply wire 60 to a welding head 51, and hence to electrical arc 50. The powder alloy feeding system 26 includes a powder feed nozzle 30 fluidly connected to an alloy powder supply 46. The welding head 51 and the powder feed nozzle 30 move in a travel direction 15 relative to the workpiece 10 when the machine is in operation. Those skilled in the art will appreciate that the welding head 51 and powder feed nozzle 30 may also oscillate in a direction into and out of the page in order to lay down a wider deposition of alloy onto the workpiece 10, without departing from the present disclosure. The powder feed nozzle 30 may be positioned and oriented to feed a powder stream 31 of alloy powder into a molten pool 11 generated on the workpiece 10 by the welding head 51 at a low temperature location 14 (e.g., below 2000° C.) behind the welding head 51 relative to the travel direction 15. After entering molten pool 11, the alloy powder mixes with the elements melted from wire 60 to form a high alloy deposit 12 after the molten pool solidifies. As one specific example, the powder feed nozzle 30 may be installed at 30-40 millimeters above the workpiece 10 and 10-15 millimeters behind the wire feeding contact tip of the welding head 51. The powder feed nozzle 30 may be configured to provide a narrow stream of alloy powder to the molten pool 11 at a rate of about 10-20 liters per minute, depending on the travel speed. Nevertheless, those skilled in the art will appreciate that a wide variety of geometric configurations would exist for satisfactorily feeding a powder stream to a target low temperature area 35, which may be on the order of about 4-5 square millimeters, at the surface 13 of molten pool 11.

Although the concepts of the present disclosure would work with any of the specialty alloy wires currently available for usage in creating hardfacing alloy deposits, hardfacing machine 20 finds preferred usage with relatively inexpensive low alloy wire. A low alloy wire according to the present disclosure includes at least one alloy element that is among the alloy powders loaded into the alloy powder supply 46 in a significant concentration, but does not include a significant concentration of at least one other alloy element among the alloy powders in the alloy powder feed supply 46. For instance, the example low alloy wire according to the present disclosure might include significant concentrations of carbon, manganese and silicon, but may not include significant concentrations of other elements, such as nickel, chromium, molybdenum, copper, titanium or tungsten, which may all be present in the alloy powder supply 46 to produce a high alloy deposit 12 for high wear resistance in abrasive conditions. Thus, in hardfacing machine 20, the wire feed system 52 may be loaded with a spool 53 of low alloy wire 60, but the alloy powder 34 in alloy powder supply 46 may include a precise predetermined mixture of alloy powders 34. Because most of the desirably usable alloy elements are available individually in suitable powders, the user can mix different concentrations of different alloy element powders to arrive at a predetermined mixture with virtually unlimited variability. This is contrasted with a finite number of different specialty wires currently available that each have a different combination of concentrations of alloy elements of interest.

FIG. 1 shows schematically that the predetermined mixture of alloy powders 34 is fed in a narrow stream 31 that impacts a contact surface 13 of molten pool 11 at a low temperature location 14 that is preferably at a temperature lower than the boiling point of the individual elements, and certainly away from the high temperature location 15 associated with the electrical arc 50. Welding unit 24 may be of a conventional design in that, in addition to the wire feed system 52 and welding head 51, it may include welding power cables 70 and 71 to provide the necessary circuit for generating electrical arc 50. In addition, welding unit 24 may include a shielding gas supply 54 that is controlled by a control valve 55 to provide a stream of shielding gas 56 around electrical arc 50 in a conventional manner.

The powder alloy feeding system 26 may include a powder stream focusing feature 37 with a first configuration at which the powder stream 31 has a first cross sectional area 35 at contact surface 13 with the molten pool 11, and a second configuration at which the powder stream 31 has a second cross sectional area at the contact surface 13 with piston pool 11. It is this aspect of hardfacing machine 20 that assists the user in delivering the alloy powder to a small target area on the molten pool 11 that has an appropriate temperature range for the alloy powders being used to avoid vaporization of the same, while encouraging appropriate mixing to produce a high alloy deposit 12 after solidification. In the illustrated embodiment, the powder stream focusing feature 37 may have a continuum of different configurations, all producing a range of different sized cross sectional areas 35 at the impact on contact surface 13. In the illustrated embodiment, the powder stream focusing feature 37 may include the powder feed nozzle 30 having a central powder opening 32 surrounded by a coaxial suppressing gas jet opening 33, as best shown in FIGS. 2 and 3. The suppressing gas may be supplied from a common gas storage 40 (e.g., gas cylinder) via a suppressing gas control valve 43 that is positioned in a suppressing supply passage 41. By controlling the flow rate of suppressing gas via appropriate adjustment of suppressing gas control valve 43, the powder stream focusing feature 37 can be adjusted to different configurations associated with different stream cross sectional areas 35 at contact surface 13.

Although not necessary, the transport gas used for moving the alloy powder through powder feed nozzle 30 may be the same gas as that used for the powder stream focusing feature 37. In the illustrated embodiment, transport gas may be supplied from common gas storage 40 through transport supply passage 42. The alloy powder mixture may be carried in suspension in the transport gas through powder feed nozzle 30. The powder alloy feeding system 26 can be thought of as including a penetration adjustment feature 39 having a first configuration at which the powder stream 31 impacts the molten pool 11 with a first momentum, and a second configuration at which the powder stream 31 impacts the molten pool 11 with a second momentum. In the illustrated embodiment, the penetration adjustment feature 39 may include a transport gas control valve 44. By adjusting transport gas control valve, a continuum of different flow rate configurations for the penetration adjustment feature 39 can be obtained to provide a continuum of different powder stream momentums. The mixture of alloy powders 34 may be supplied to the powder feed nozzle 30 via a powder supply passage 45. The powder 34 may be mixed with the transport gas at any appropriate location, including within the powder feed nozzle 30. Referring specifically to FIGS. 2 and 3, one example powder feed nozzle 30 may supply suppressing gas via four separate passages 41 that merge at circular chamber 47 to equalize the pressure before emerging through the donut shaped suppressing gas jet opening 33 that surrounds the central powder opening 32, which carries the powder mixture 34 suspended in the transport gas. In the illustrated embodiment, the powder feed nozzle 30 may also be cooled, such as via an outer water cooling jacket passage 49 that is connected to a fluid circulation system (not shown) but well known in the art.

The powder feed nozzle 30 may be connected to move with the welding head 51 in the travel direction 15. A positioning adjustment feature 38 may have a first configuration at which the powder feed nozzle 30 has a first position and orientation relative to the welding head 51, and a second configuration at which the powder feed nozzle 30 has a second position and orientation with respect to welding head 51. In the illustrated embodiment, positioning adjustment feature 38 may comprise a simple adjustable bracket that allows the user to precisely position and orient powder feed nozzle 30 with regard to the welding head 51 so that the powder stream 31 is directed at the desired low temperature location 14 in the molten pool 11. Thus, by using a simple adjustable bracket, a continuum of different position and orientation configurations are available to suit any desired aiming of powder feed nozzle 30 with respect to welding head 51 and the various temperature locations in molten pool 11.

The present disclosure recognizes that even low alloy wire 60 includes some significant concentration of elements that may be desired in the final high alloy deposit 12. The present disclosure also recognizes that because of the melting temperatures of those desired alloy elements present in the low alloy wire, substantial amounts of those alloy elements may be vaporized in the high temperature location 15 associated with electrical arc 50. However, even if a substantial fraction of those alloy elements are vaporized, a measurable concentration will or may survive the high temperature area 15 to become a portion of the high alloy deposit 12. Thus, the present disclosure recognizes that, in determining various concentrations of alloy element powders in a predetermined mixture of powders 34, one can take into account the expected vaporization rate of alloy elements that are portions of the low alloy wire 60 and maybe the concentration in the base material of workpiece 10, and provide the remaining desired concentration in the form of alloy element powder 34. For instance, in one specific high alloy deposit, carbon, manganese and silicon may be provided both from the low alloy wire and from the predetermined powder mixture 34 in reaching the high alloy deposit 12. But all of the desired nickel, chromium, molybdenum, copper, titanium and tungsten may all come from the powder mixture 34. The various fractions of the carbon, manganese and silicon should take into account the expected vaporization rates of those respective elements while passing through the high temperature area 15 associated with electrical arc 50. The following equation may be useful in calculating a composition of the predetermined powder mixture 34 for hardfacing machine 20:

Ke_{powd}=1/Dpowd_{depos}×(Ke_{depos}−Ke_{wire}×DWire_{depos}−Ke_{base}×Dbase_{depos})

Ke_{powd}—concentration of the element in powder mixture;
Ke_{depos}—required concentration of the element in deposit;
Ke_{wire}—concentration of the element in metal core wire;
Ke_{base}—concentration of the element in base metal;
Dpowd_{depos}—fraction of powder mixture in deposit;
Dwire_{depos}—fraction of wire metal in deposit;
Dbase_{depos}—fraction of base metal in deposit.
n general, fraction can be defined by:

Dpowd_{depos}=Vpowd_{depos}/Vdepos,

Vpowd_{depos}—volume of metal powder in bulk of deposit;
Vdepos—volume of the deposit.

### INDUSTRIAL APPLICABILITY

The present disclosure finds potential application in any situation where there is a desire to create a high alloy deposit 12 on a workpiece 10 using an arc welding technique. The present disclosure finds particular applicability in those instances where there is a desire to limit vaporization of alloy elements during the hardfacing deposit procedure. Although the present disclosure has been illustrated in the context of depositing a hardfacing alloy onto a workpiece 10, the present disclosure also finds potential application to apply crack-sensitive weld materials to a metal workpiece. The present disclosure also finds potential application for the development of new high alloy deposit compositions by affording the user the ability to combine virtually any combination of available alloy powders in virtually any relative percentages to arrive at potentially previously unknown high allow deposit compositions. This variability offers the user the ability to arrive at new high alloy compositions to combat various combinations of temperature, corrosion and various types of wear that may occur in existing and future machines.

When in operation, the method of arc alloy deposition generally, and hardfacing in particular, includes generating an electrical arc 50 between a wire 60 of welding head 51 and a workpiece 10. The wire 60 is melted into a molten pool 11 with the electrical arc 50 on the workpiece 10. The welding head 51 is moved with respect to the workpiece 10 in a travel direction 15. A mixture of powder alloys 34 is added to the molten pool 11. Vaporization of a portion of the mixture of powder alloys is limited by penetrating a powder stream 31 of the alloy powders into the molten pool 11 at a low temperature location 14 behind the electrical arc 50 relative to the travel direction 15. Thereafter, the molten pool 11 is solidified into the high alloy deposit 12.

In one specific method, the hardfacing machine 20 may utilize low alloy wire 60 that is fed to the welding head 51 from a spool 53, while the welding head 51 is moving in travel direction 15. When using a low alloy wire 60, at least one alloy element is supplied to the molten pool 11 from both the low alloy wire 60 and the predetermined mixture of alloy powders 34. On the otherhand, at least one other alloy element is supplied to the molten pool only from the predetermined mixture of alloy powders 34. By using the equations set forth earlier and by determining expected vaporization losses from various elements in the wire 60, and maybe the base material of workpiece 10, the user may set a concentration of at least one alloy element in the predetermined mixture 34 responsive to the expected vaporization loss of the at least one alloy element. For instance, by knowing the expected vaporization loss of manganese from the low alloy wire 60, one can determine and calculate a precise concentration of manganese for the predetermined mixture of alloy powder 34 to arrive at a predetermined desired composition in the high alloy deposit 12. The present disclosure also recognizes that less than 100% of the added powder may end up in the high alloy deposit 12. Thus, powder alloy losses might also need to be accounted for when arriving at the predetermined mixture of alloy powders 34. In order to produce the best possible results, it may be necessary to change the powder stream focusing feature 37, the penetration adjustment feature 39 and/or the positioning adjustment feature 38 before and/or after setting a precise composition of different alloy powders in the powder alloy mixture 34 to arrive at a desired high alloy deposit 12 that exhibits the desirable set of characteristics for a given circumstance. For instance, the powder stream focusing feature 37 may be changed by adjusting a flow rate of suppressing gas through powder feed nozzle 30 via appropriate adjustment of suppressing gas control valve 43. The position adjustment feature may be adjusted by loosening the position adjustment feature 38 reorienting and positioning the powder feed nozzle 30 and then tightening the position adjustment feature 38 in a new configuration. Finally, the penetration adjustment feature 39 may be changed by adjusting transport control valve 44 to produce a desired impact momentum of the powder stream 31 at contact surface 35.

The hardfacing machine 20 has the advantage of allowing virtually any composition of alloy elements in any desirable concentration in the hard alloy deposit 12. In addition, this variability advantage can be achieved by limiting vaporization losses of potentially expensive alloy elements. Tests have suggested that up to 90% or more of the alloy powder finds its way into the high alloy deposit 12. An additional benefit may be decreasing of heat input and sensitivity to cracking for alloy deposits by increasing the solidification rate with the feeding of cold powder elements 34 into the molten pool 11. Thus, hardfacing machine 20 affords the possibility of reproducing hard alloy deposits of known chemistry but with reduced vaporization losses, and hence cost savings over prior art techniques. In addition, the hardfacing machine 20 also potentially affords the possibility of new hard alloy deposit composition chemistries, including potentially previously unknown compositions that may not have been possible with current arc based deposition techniques. This might be accomplished by using elements with relatively low boiling points that would have previously been thought unthinkable in usage with the prior art strategy. Thus, hardfacing machine 20 also provides for a potential research tool in arriving at, and testing, previously unknown hard alloy deposits for virtually every workpiece wear situation both known and to be known.

It should be understood that the above description is intended for illustrative purposes only, and is not intended to limit the scope of the present disclosure in any way. For instance, although the present disclosure has been illustrated in the context of arc hardfacing a workpiece with a high alloy deposit 12, the machine 20 and method of operation could also apply to welding of crack-sensitive metals. By utilizing the same powder feeding nozzle 30, but a different mixture of powders, a crack avoidance effect can be achieved through acceleration of crystallization, refining the weld structure and controlling the weld cooling rate. This may decrease weld crack sensitivity in some applications. Thus, those skilled in the art will appreciate that other aspects of the disclosure can be obtained from a study of the drawings, the disclosure and the appended claims.

What is claimed is:

1. An alloy depositing machine, for depositing an alloy onto a workpiece, comprising:
a workpiece support for supporting a workpiece;
welding unit includes a wire feed system to supply wire to a welding head;
a powder alloy feeding system, includes a powder feed nozzle fluidly connected to an alloy powder supply;
wherein the welding head and powder feed nozzle move in a travel direction relative to a workpiece;
wherein the powder feed nozzle is positioned and oriented to feed a powder stream of alloy powder into a molten pool generated on the workpiece by the welding head at a low temperature location behind the welding head relative to the travel direction.

2. The machine of claim 1 wherein the wire feed system is loaded with a spool of low alloy wire;
the alloy powder supply is loaded with a predetermined mixture of alloy powders;
at least one alloy element among the alloy powders is of a significant concentration in the low alloy wire; and
at least one other alloy element among the alloy powders is not of a significant concentration in the low alloy wire.

3. The machine of claim 2 wherein a concentration of the at least one alloy element in the predetermined mixture is responsive to an expected vaporization loss of the at least one alloy element from the low alloy wire.

4. The machine of claim 1 wherein the powder alloy feeding system includes a powder stream focusing feature with a first configuration at which the powder stream has a first cross sectional area at a contact surface with the molten pool, and a second configuration at which the powder stream has a second cross sectional area at the contact surface with the molten pool.

5. The machine of claim 4 wherein the powder stream focusing feature includes the powder feed nozzle having a central powder opening surrounded by a suppressing gas jet opening; and
a flow rate of suppressing gas through the suppressing gas jet opening being different in the first configuration from the second configuration.

6. The machine of claim 5 wherein the powder alloy feeding system includes a common gas storage fluidly connected to the suppressing gas jet opening by a suppressing supply passage, and fluidly connected to the central powder opening by a transport supply passage.

7. The machine of claim 1 wherein the powder feed nozzle is connected to move with the welding head; and
a positioning adjustment feature having a first configuration at which the powder feed nozzle has a first position and orientation relative to the welding head, and a second configuration at which the powder feed nozzle has a second position and orientation relative to the welding head.

8. The machine of claim 1 wherein the powder alloy feeding system includes a penetration adjustment feature having a first configuration at which the powder stream impacts the molten pool with a first momentum, and a second configuration at which the powder stream impacts the molten pool with a second momentum.

9. The machine of claim 8 wherein the penetration adjustment feature includes a transport gas control valve.

10. The machine of claim 1 wherein the wire feed system is loaded with a spool of low alloy wire;
the alloy powder supply is loaded with a predetermined mixture of alloy powders;
at least one alloy element among the alloy powders is of a significant concentration in the low alloy wire;
at least one other alloy element among the alloy powders is not of a significant concentration in the low alloy wire;
wherein the powder alloy feeding system includes a powder stream focusing feature with a first configuration at which the powder stream has a first cross sectional area at a contact surface with the molten pool, and a second configuration at which the powder stream has a second cross sectional area at a contact surface with the molten pool;
wherein the powder feed nozzle is connected to move with the welding head;
a positioning adjustment feature having a first configuration at which the powder feed nozzle has a first position and orientation relative to the welding head, and a second configuration at which the powder feed nozzle has a second position and orientation relative to the welding head; and
a penetration adjustment feature having a first configuration at which the powder stream impacts the molten pool with a first momentum, and a second configuration at which the powder stream impacts the molten pool with a second momentum.

11. A method of depositing an alloy onto a workpiece, comprising the steps of:
generating an electrical arc between a wire of a welding head and a workpiece;
melting the wire into molten pool with the electrical arc on the workpiece;
moving the welding head with respect to the workpiece in a travel direction;
adding a mixture of powder alloys to the molten pool;
limiting vaporization of a portion of the mixture by penetrating a powder stream of the powder alloys into the molten pool at a low temperature location behind the electrical arc relative to the travel direction;
solidifying the molten pool.

12. The method of claim 11 including a step of feeding a low alloy wire to the welding head during the moving step; and
loading an alloy powder supply with a predetermined mixture of the alloy powders;
supplying at least one alloy element to the molten pool from both the low alloy wire and the predetermined mixture of the alloy powders; and
supplying at least one other alloy element from only the predetermined mixture of the alloy powders.

13. The method of claim 12 including a step of setting a concentration of the at least one alloy element in the predetermined mixture responsive to an expected vaporization loss of the at least one alloy element from the low alloy wire.

14. The method of claim 11 including a step of changing a powder stream focusing feature from a first configuration at which the powder stream has a first cross sectional area at a contact surface with the molten pool to a second configuration at which the powder stream has a second cross sectional area at the contact surface with the molten pool.

15. The method of claim 14 wherein changing step includes adjusting a flow rate of suppressing gas through a powder feed nozzle.

16. The method of claim 15 including a step of transporting the mixture of alloy powders through a central opening in the powder feed nozzle with a transport gas; and
supplying the transport gas and the suppressing gas from a common gas storage.

17. The method of claim 11 including a step of adjusting a positioning adjustment feature from a first configuration at which a powder feed nozzle has a first position and orientation relative to the welding head, and a second configuration at which the powder feed nozzle has a second position and orientation relative to the welding head.

18. The method of claim 11 including a step of adjusting a penetration adjustment feature from a first configuration at which the powder stream impacts the molten pool with a first momentum to a second configuration at which the powder stream impacts the molten pool with a second momentum.

19. The method of claim 18 wherein the adjusting step includes changing a flow rate a transport gas.

20. The method of claim 11 including a step of feeding a low alloy wire to the welding head during the moving step; and
loading an alloy powder supply with a predetermined mixture of the alloy powders;
supplying at least one alloy element to the molten pool from both the low alloy wire and the predetermined mixture of the alloy powders;
supplying at least one other alloy element from only the predetermined mixture of the alloy powders;
changing a powder stream focusing feature from a first configuration at which the powder stream has a first cross sectional area at a contact surface with the molten pool to a second configuration at which the powder stream has a second cross sectional area at the contact surface with the molten pool;
adjusting a positioning adjustment feature from a first configuration at which a powder feed nozzle has a first position and orientation relative to the welding head to a second configuration at which the powder feed nozzle has a second position and orientation relative to the welding head; and
adjusting a penetration adjustment feature from a first configuration at which the powder stream impacts the molten pool with a first momentum to a second configuration at which the powder stream impacts the molten pool with a second momentum.
